(19) United States
(12) Patent Application Publication
(10) Pub. No.: US 2015/0087372 A1
(43) Pub. Date: Mar. 26, 2015

(54) System and Method to Implement a Wagering Game

(71) Applicant: Chi Fat Au-Yeung, Birmingham (GB)

(72) Inventor: Chi Fat Au-Yeung, Birmingham (GB)

(21) Appl. No.: 14/033,459

(22) Filed: Sep. 21, 2013

(51) Int. Cl. A63F 1/00; G07F 17/32

(52) U.S. Cl. CPC A63F 1/00; G07F 17/3244; G07F 17/3279; A63F 2001/003
USPC 463/12

(57) ABSTRACT

A method, system, and computer readable storage to implement a variation of a blackjack game. The player must hit a hard total less than fourteen (or other number) and stand on a hard total greater than thirteen (or other number). If the player has a soft total the player has the option to hit or stand. The system can also include a networked embodiment wherein the player can connect to an online server and play the game remotely using a remote client, for free or for real money.

### BACKGROUND OF THE INVENTION

1. Field of the Invention

The present general inventive concept is directed to a method, apparatus, and computer readable storage medium directed to a wagering game.

2. Description of the Related Art

The casino game of blackjack is well known, for example see U.S. Patent publication 2003/0155715 which is incorporated by reference herein in its entirety.

FIG. 1 is a flowchart illustrating a method of implementing the known game of blackjack.

Points totals are computed by adding the standard rank value of each card, with face valued cards (tens, jacks, queens, kings) being given a value of 10, and aces being given a value of 1 or 11, whichever results in a better hand. A soft point total is where at least one ace is given the value of 11. A hard point total is a hand with all aces counting as 1.

In operation 100, the player makes a main wager by placing chips on a table. Then, in operation 102, the dealer deals two initial cards to each player (either face up or face down) and two initial cards to the dealer, typically one face down (“hole-card”), and one face up (the “up-card”). Then the player can decide whether to hit, stand, double, or split. If the player decides to hit, then the method proceeds to operation 106, which deals an additional card to a player. If a determination 108 determines that the player has busted (the player's hard point total is over 21), then the player loses the game and thus loses the main wager in operation 110, which ends the game. If the determination 108 determines that the player has not busted, then the method returns to operation 104, where the player can make another decision whether to hit or stand. In operation 104, the player can also double (not pictured) by place an additional wager of up to the main wager, but the player is limited to drawing only one additional card before the player must stand.

If the player stands and has not busted out (either stands on his or her initial two cards or draws cards but has a point total under 22 and then stands), then the method proceeds to operation 112, which reveals all dealer's cards (e.g., turns the hole-card face up) and which then plays out the dealer's hand according to predetermined rules. In operation 114, if the dealer's total is greater than a predetermined amount (typically 17), then the dealer stands (proceeds to operation 122). If the dealer's total is not greater than the predetermined amount, the method proceeds to operation 116 which deals an additional card to the dealer. If it is then determined 118 that the dealer has not busted (has a point total over 21), the method returns to operation 114. If the dealer has busted, then the player wins the game and the main wager in operation 120 (this assumes the player has not also busted; if the player has already busted then the player would have lost in operation 110).

In operation 122, both the player and the dealer have played out their hand and neither have busted. Thus, their respective point totals (adding the numerical values of each card in the hand) are compared. If the dealer's point total is determined in operation 124 to be lower than the player's point total, then the player wins the game and the main wager in operation 120. Otherwise, if the dealer's point total is determined 128 to be greater than the player's point total, then the player loses the game and the main wager in operation 130. If the player's point total ties the dealer's point total, then that results in a “push” in operation 126 in which the player doesn't win or lose the main wager (the main wager is a wash).

If a player is initially dealt two identically ranked cards in operation 102, players can also split in operation 104 by placing an additional split wager equal in value to the main wager, and the player's two initial cards are separated and the dealer deals an additional card on each. The player then plays out each of the two separate hands, each from operation 104. Depending on house rules, players may or may not be allowed to resplit cards.

### SUMMARY OF THE INVENTION

It is an aspect of the present invention to provide a casino blackjack improvement.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating a method of implementing the known game of blackjack;

FIG. 2 is a flowchart illustrating an exemplary method of implementing a blackjack game with expeditious gameplay, according to an embodiment;

FIG. 3 is a further flowchart illustrating an exemplary method of implementing a blackjack game with expeditious gameplay, according to an embodiment;

FIG. 4 is a flowchart illustrating an exemplary method of implementing a side wager to a blackjack game, according to an embodiment;

FIG. 5A is a drawing illustrating a gaming table, according to an embodiment;

FIG. 5B is a block diagram illustrating an electronic player tracking system associated with each gaming table, according to an embodiment;

FIG. 6A is a block diagram illustrating exemplary hardware that can be used to implement an electronic version of the methods described herein; and

FIG. 6B is a block diagram illustrating an exemplary network configuration to implement a player playing an online version of the methods described herein;

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a blackjack

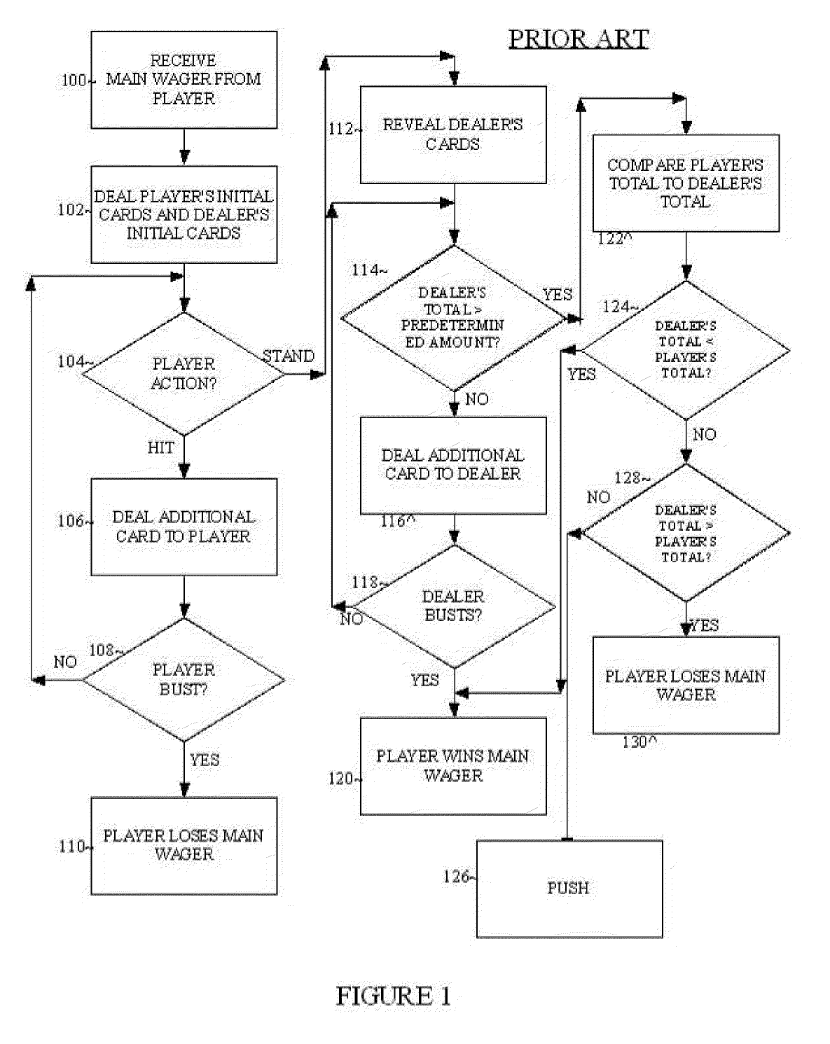

FIG. 1 is a flowchart illustrating a method of implementing the known game of blackjack.

In general, casino blackjack is played by one or more players at a gaming table against a dealer using one or more decks of cards (each deck can be a standard 52 card deck). The idea is for the player to make a point total closest to 21 without going over 21 (busting). Each player (after making a main wager) is dealt two initial cards (typically face up) and the dealer is also dealt two cards (one face up—the upcard, and one face down—the hole card). The player can stand on his or her initial two cards, or continuously hit (take another card) until the player stands or the player's point total is over 21 (upon which the player automatically loses). If the player has not busted, then after the player stands the dealer will play out the dealer's hand according to predetermined rules. One set of dealer predetermined rules is as follows: the dealer will continuously hit until the dealer's point total is greater than 16. Once the dealer has resolved the dealer's hand, the wager is resolved. If the player has busted then the player loses (the main wager). If the player has not busted but the dealer has busted (the dealer's point total is over 21) then the player wins (wins even money on the main wager). If both the player and the dealer have not busted, then if the player's point total is higher than the dealer's point total then the player wins (wins even money on the main wager). If both the player and the dealer have no busted, then if the dealer's point total is higher than the player's point total then the dealer wins (the player loses the main wager). If the player's point total equals the dealer's point total, then the main wager pushes (neither wins nor loses). Other options the player may have at his or her disposal is to double down or split. Cards are given their standard numerical value (i.e., aces count as 1 or 11 (whichever makes the best hand), 2's-10's count as their respective face value, jacks, queens, and kings all count as 10).

An embodiment relates to a variation of the known game of blackjack which provides a quicker resolution of hands with limited player decisions. The player is dealt his or her hand and the game plays like the standard game of blackjack (illustrated in FIG. 1) with the following exceptions: a) when the player busts (gets a point total over 21) the player loses ½ of the main wager; b) players must hit hard totals of 13 or lower except when doubling; c) players must stand on hard totals of 14 or higher; d) players may hit or stand on soft totals; e) players may double down on a 2 card hand (the initial two cads dealt) when the player's total is 13 or lower or is a 2 card soft total (double downs only receive one card); f) blackjacks pay even money. Soft point totals are hands that include an ace wherein the ace can count as 1 or 11 and the total for the hand still does not bust (is not over 21). Hard point totals are hands which do not have an ace which can count as 11. A point total is either hard or soft (but not both). When an ace can count as 1 or 11 the value used (1 or 11) is the one which gives the hand the best point total (closest to 21 without going over).

Table I below illustrates one exemplary set of rules although it can be appreciated that other rule variations can be used as well.

TABLE I
Player must hit hard totals of 13 or lower.
Player must stand on hard totals of 14 or higher.
Player may double-down on two card hard totals of 13 or lower, or on two
card soft totals.
Double-downs receive only one card.
Player may hit or stand on soft totals.
Player busts only lose ½ of the hand wager.
Winning (non-push) blackjacks pay even-money (1:1).
Double-down after split allowed.
No late surrender offered.
Split Aces receive only one card.
Non-Aces may be re-split up to 4 hands (SP4).
The following are the optional rules:
The dealer stands on soft-17 (S17), or hits on soft-17 (H17).
Aces may not be re-split (SPA2), or split up to 4 hands (SPA4).
The dealer is dealt a hole card (full-peek), or is not dealt a hole card
(European rule).

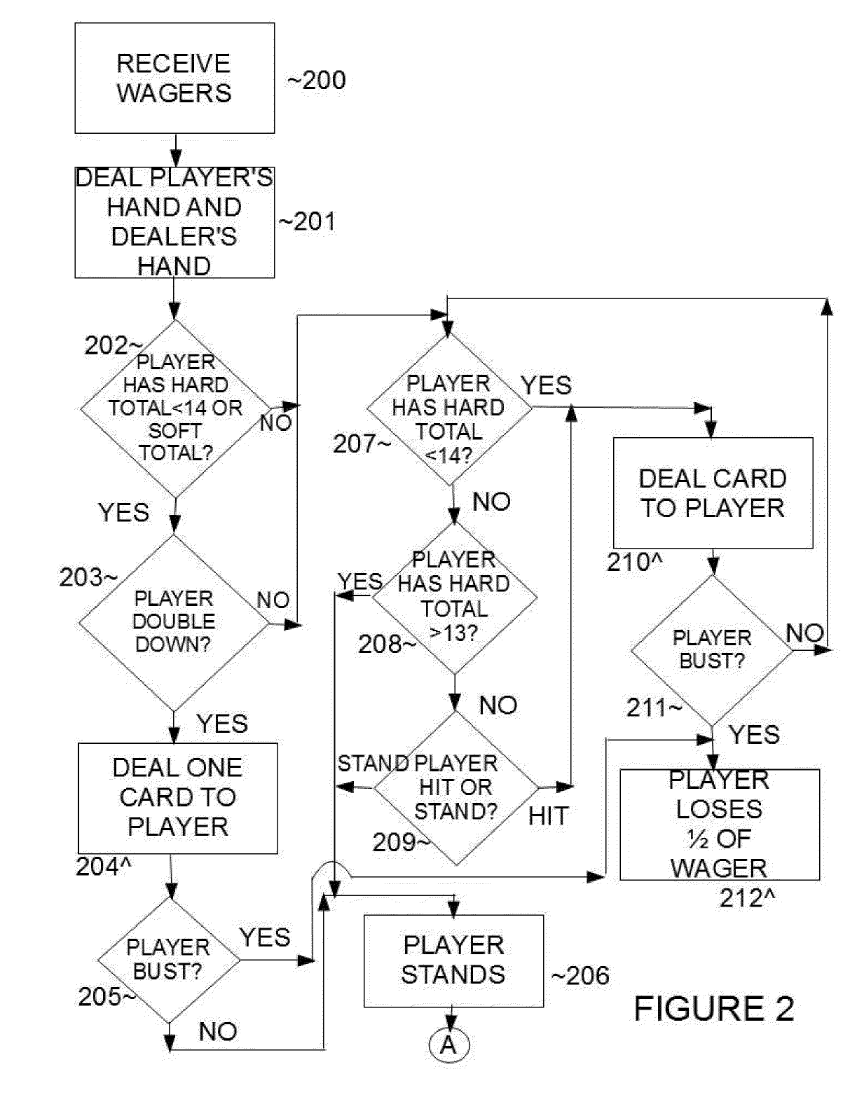

FIG. 2 is a flowchart illustrating an exemplary method of implementing a blackjack game with expeditious gameplay, according to an embodiment.

The method can begin with operation 200, which receives wagers from the player. The wagers received are the main wager (which is resolved based on an outcome of the game) and any optional side wager(s) which may be offered by the house. The main wager is received by the house by the player placing chip(s) in a main wager betting circle on the table. Side wagers are received by the house by the player placing chip(s) in a side wager betting circle(s) on the table. The chips are directly redeemable for cash.

From operation 200, the method proceeds to operation 201, which deals the player's hand and the dealer's hand. The player's hand is two cards, typically dealt face up although if they are dealt face down the player is able to view both cards. The dealer's initial hand comprises an up-card (a card dealt face up). In one embodiment, the dealer's initial hand also comprises a hole-card (a card dealt face down so the player does not know its value until it is turned up). In another embodiment, the dealer's initial hand is only one card and additional cards are dealt to the dealer at a later point in time (known as the European hole card rule). In operation 201, if the player is dealt a blackjack (an ace and a 10-valued card (ten, jack, queen, or king)) then the player has an instant winner and wins even money (1:1) for the main wager unless the dealer also has blackjack in which the player's main wager pushes.

From operation 201, the method proceeds to operation 202, which determines whether the player's hard point total (the sum of the point value of all cards in the player's hand) is less than 14 or is a soft total (e.g., has an ace). If the player's point total is less than 14 or the player's hand is a soft hand (has a soft total) then the method proceeds to operation 203. If the player's hard point total (where aces must count as 1) is not less than 14 or the player does not have a soft total then the method proceeds to operation 207.

In operation 203, it is determined whether the player doubles down. If the player does not double down (which can be indicated to the dealer by the player using verbal or physical gestures or actions) then the method proceeds to operation 207.

If the player doubles down in operation 203, then the method proceeds to operation 204, which deals one card (a double card) to the player.

From operation 204, the method proceeds to operation 205, which determines if the player busts. If the player's hard point total (i.e. all aces must count as 1) is greater than 21 then the player busts and the method proceeds to operation 212.

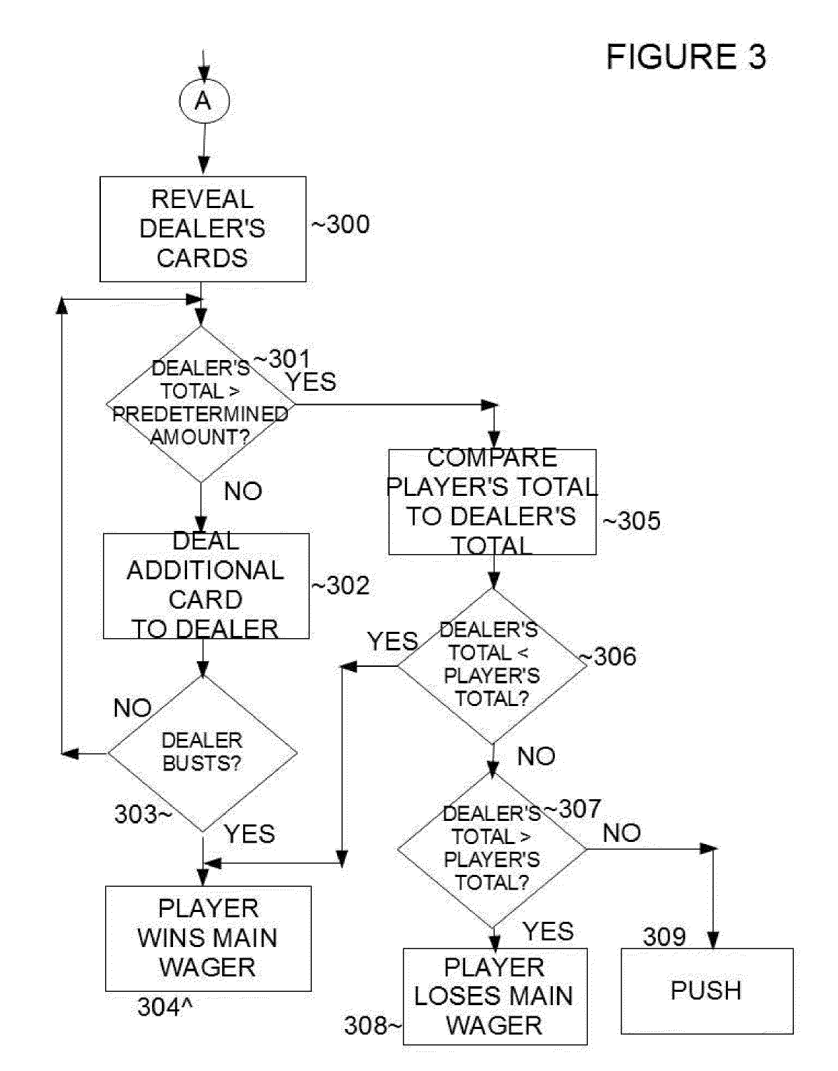

If in operation 205, the player has not busted (the player's hard point total is not greater than 21) then the method proceeds to operation 206 wherein the player stands (since the player doubled in operation 203 the player only gets one additional draw card so now the player must stand). The method proceeds to connector A in FIG. 3.

If in operation 202 the player does not have a hard point total less than 14 or has a soft point total then the method proceeds to operation 207. If in operation 203 the player did not double down then the method proceeds to operation 207. In operation 207, it is determined whether the player has a hard point total less than 14. If the player does not have a hard point total less than 14 (e.g., the player's hard point total is 14 or higher), then the method proceeds to operation 208.

In operation 208 it is determined whether the player has a hard point total greater than 13. If the player has a hard point total greater than 13 (i.e. 14 or higher) then the method proceeds to operation 206 wherein the player must stand. If the player does not have a hard point total greater than 13 (e.g., the player's hard point total is 13 or less), then the method proceeds to operation 209.

In order to reach operation 209, the player must have a soft point total. If in operations 207 and 208 the player has a soft point total (e.g., an ace that can count as 11 without causing the hand total to be over 21) then the conditions in operations 207 and 208 would both result in “NO.” In operation 209, the player can choose to hit or stand. If the player chooses to stand, then the method proceeds to operation 206. If in operation 209 the player chooses to hit, then the method proceeds to operation 210.

In operation 210, a card is dealt to the player (typically face up). All cards dealt to the player and dealer are dealt from a deck (or shoe) which is typically shuffled before the game so the cards dealt are random.

From operation 210, the method proceeds to operation 211, which determines whether the player has busted. The player has busted if the players hard point total (all aces counting as 1) is greater than 21. If the player has not busted, then the method returns to operation 207.

If the player has busted (in operation 205 or operation 211) then the method proceeds to operation 212, wherein the player loses one half of the main wager (placed in operation 200).

Note that in an embodiment, the player automatically hits when the player has a hard point total of less than 14 (X+1) (operation 207) and stands when the player has a hard point total greater than 13 (X) (operation 208). Note that while X equals 13, in other embodiments X can be adjusted to be other numbers as well (e.g., 11, 12, 14, 15, 16, 17, 18, etc.)

FIG. 3 is a further flowchart illustrating an exemplary method of implementing a blackjack game with expeditious gameplay, according to an embodiment.

From connector A in FIG. 3 (which continues from connector A in FIG. 2), operation 300 is performed (in other words, from operation 206, the method proceeds to operation 300). Operation 300 reveals the dealer's cards. In the embodiment where the dealer was initially dealt (in operation 201) an up-card and a hole-card, the hole-card is now turned face up (revealed). In the embodiment where the dealer was initially dealt only an up-card (the “European hole card rule”), now a second dealer's card is dealt to the player face up.

From operation 300, the method proceeds to operation 301. Operations 301, 302, 303, 304, 305, 306, 307, 308, and 309 are implemented the same as operations 114, 116, 118, 120, 122, 124, 128, 130, 126, respectively. In operation 301, in one embodiment, the predetermined amount is 16 (thus the dealer hits on 16 and stands on 17), while in one embodiment the dealer stands on soft 17 and in another embodiment the dealer hits on soft 17 and stands on soft 18. When the player wins the player wins even money (1:1) on the main wager and when the player loses the player loses the player loses the entire main wager. Thus, once the player is completed playing out the players hand (FIG. 2), the rest of the game (the way the dealer resolves the dealer's hand and the way the main wager is resolved) is the same as in convention blackjack (FIG. 1).

An example of the game will now be presented. Jack places a $1 main wager. Jack is dealt a 7-spades/6-hearts (note the suits do not matter in this game). The dealer is dealt an 8-hearts face up (upcard) and a hole-card (face down). Since Jack has a hard 13 which is less than 14 (operation 202), jack has the option to double down. Jack declines to double down and since Jack has a hard 13 which is less than 14 (operation 207) then Jack is automatically given a card (i.e. Jack hits, Jack cannot stand). The hit card dealt (operation 210) is a 3 spades giving Jack a total of 16. Since 16 is not less than 14 (operation 207) and 16 is greater than 13 (operation 208) then Jack must stand (operation 206). The dealer reveals (operation 300) the hole-card to be a 10-spades, giving the dealer a point total of 18. Since 18>16 (operation 301) the dealer stands and the dealer's point total (18) is compared (operation 305) to the player's point total (14) in order to determine the winner. Since the dealer's point total is higher than the player's point total the player loses his $1 main wager (operation 308) and the game ends. Note that anywhere “point total” appears herein is synonymous with “total.”

As another example, Jill places a $1 main wager. The dealer (or computer in the electronic version) deals Jill an ace-clubs and a 5-hearts (for a total of soft 6 or soft 16). Since the player has a soft total (operation 202), Jill (the player) has the option to double down (place a $1 double wager and take only one card). Jill declines to double down and thus decides to hit (operation 209). The dealer deals Jill an ace-diamonds, giving Jill a total of soft 7 or soft 17. Since this is a soft total, Jill once again has the option (operation 209) to hit or stand. Jill decides to hit again and is dealt a 5-clubs giving Jill a total of hard 12. Since Jill's total (total of the player's hand) is less than 14 (operation 207), Jill must automatically take a hit which is a 10-diamonds for a total of 22. Since Jill has busted (operation 211) by virtue of the point total being over 22, then Jill loses $0.50 (operation 212) and thus the dealer takes Jill's $1 chip and replaces it with a $0.50 chip and the game is over.

In a further embodiment, an optional blackjack side wager is offered to the player. The side wager can be played with the blackjack variation described herein, the standard game of blackjack (for example illustrated in FIG. 1) or any other version of blackjack.

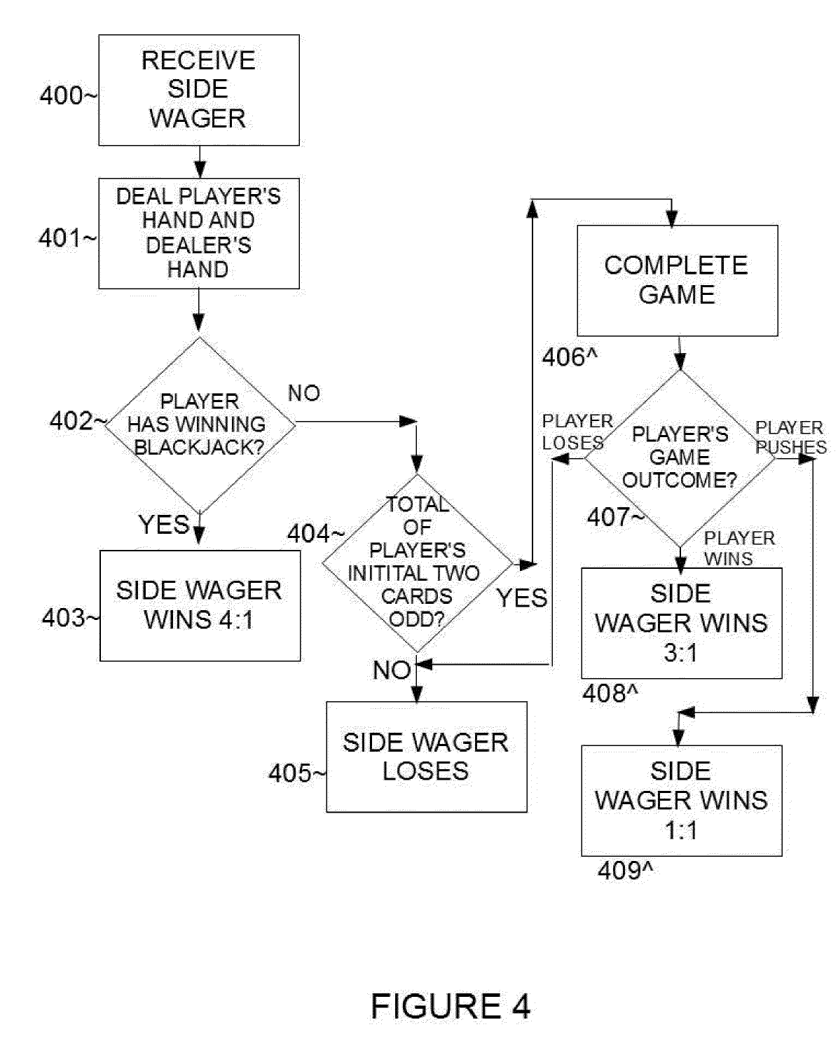

FIG. 4 is a flowchart illustrating an exemplary method of implementing a side wager to a blackjack game, according to an embodiment.

The method can begin with operation 400, which receives a side wager from a player. This can be made along with the main wager (such as in operation 100).

From operation 400, the method proceeds to operation 401 which deals the player's hand and the dealer's hand (this is done as in operation 102).

From operation 401, the method proceeds to operation 402, the method proceeds to operation 402 which determines whether the player has a winning blackjack (a 2 card point total of 21) or not. A winning blackjack is where the player has blackjack and the dealer does not have blackjack. If the player has a winning blackjack, then the method proceeds to operation 403, wherein the side wager wins a payout of 4:1 and the side wager is fully resolved (no further payouts are possible in the same game). If the player does not have a winning blackjack then the player has a tie blackjack (the dealer has blackjack also) in which the method illustrated in FIG. 4 would proceed and end up at operation 409 which is where there is a push. Note that a player blackjack (21) is an odd total thus qualifies in operation 404 to continue.

If in operation 402, the player does not have blackjack, then the method proceeds to operation 404, which determines whether a point total of the player's initial two cards is odd. In other words, the point values for each card in the two card initial hand are added (each card counts as its face value with jacks, queens, kings counting as 10 and aces counting as 1 (or eleven, it doesn't matter)). If this total is even, then the method proceeds to operation 405 and the side wager automatically loses (it can be taken from the player now or at the end of the game).

In another embodiment, instead of the point total of the player's initial two cards being required to be odd to qualify for winning the side wager, the player's initial two cards have to be even while an odd point total automatically loses the side wager. Thus, for example, in operation 404, it is determined whether the point total of the player's initial two cards is even, not odd, but otherwise the method operates in the same manner.

If in operation 404, it is determined that the total of the player's initial two cards are odd, then the method proceeds to operation 406, which completes the blackjack game. This can be done as illustrated in FIG. 1 (starting at operation 104 since operations 100 and 102 have already been performed as operations 400 and 401). The game result is a player win if operation 120 is reaches, the game result is a player loss of operation 110 or 130 is reached, and the game result is a push if operation 126 is reached. Thus, operation 406 completes the entire blackjack game and returns with a result (win, loss, push) for the player. Different variations of a blackjack game can be implemented in operation 406, FIG. 1 is merely one example (a standard game) but other types of blackjack games can be implanted in operation 406 as well.

From operation 406, the method proceeds to operation 407, which determines what the game outcome is from operation 406. If the game outcome is a loss, then the method proceeds to operation 405 in which the side wager loses (and is taken from the player). The player's main wager would have lost as well.

If in operation 407, the game result (outcome) is that the player wins, then the side wager wins a payout of 3:1 and the side wager is fully resolved. The player's main wager would have won as well.

If in operation 407, the game result is that the player pushes, then the method proceeds to operation 409 wherein the side wager wins 1:1 (even money) and the side wager is fully resolved. The player's main wager would have pushed as well.

Note the payouts described herein (4:1 for a player blackjack, 3:1 for a game win, 1:1 for a game push) can of course be modified and other payouts can be used as well.

An example of the side wager (applied to the standard game of blackjack) will now be presented. Jane bets a $2 main wager and a $1 side wager. Jane is dealt a 10-clubs/9-diamonds. The dealer is dealt a 7-diamonds up-card and a hole-card face down. Jane decides to stand. Since Jane's point total is odd, the side wager remains live. The dealer then reveals (operation 112) the hole-card to be a 6-spades for a point total of 13. The dealer then draws (operation 116) a nine-hearts for a point total of 22. The dealer busts (operation 118 goes to operation 120) and the player wins the main wager. Thus, Jane wins $2 for the main wager and $3 on the side wager for a total of $5 profit (the $3 Jane originally wagered is still on the table). The game is now over, Jane can collect the $8 in chips on the table and a new game can begin. Note that if Jane was original dealt an even point total (e.g., two 10's) then Jane would immediately lose the side wager (but the game continues to resolve the main wager).

As another example of the side wager, Tina places a $1 main wager and a $1 side wager. Tina is dealt an initial hand of 10-hearts and 9-spades. The dealer is dealt an upcard of Ace and a hole-card (face down). Tina decides to stand. Since Tina's point total is odd (19), the side wager remains live (if the point total was even then the side wager would automatically lose). The dealer then reveals the hole card to be a 8-hearts (for a point total of soft 19). The dealer stands (operation 114 goes to operation 122) then the two hands are compared. Since the player's total and the dealer's total are equal (19), the game result (outcome) is a push. Tina pushes her $1 main wager (neither wins nor loses). Tina wins $1 on the side wager (operation 409). Thus, Tina originally wagered $2 and won $1 on the side wager while not losing the main wager (pushing), thus Tina has $3 in chips on the table to take now (for a profit of $1).

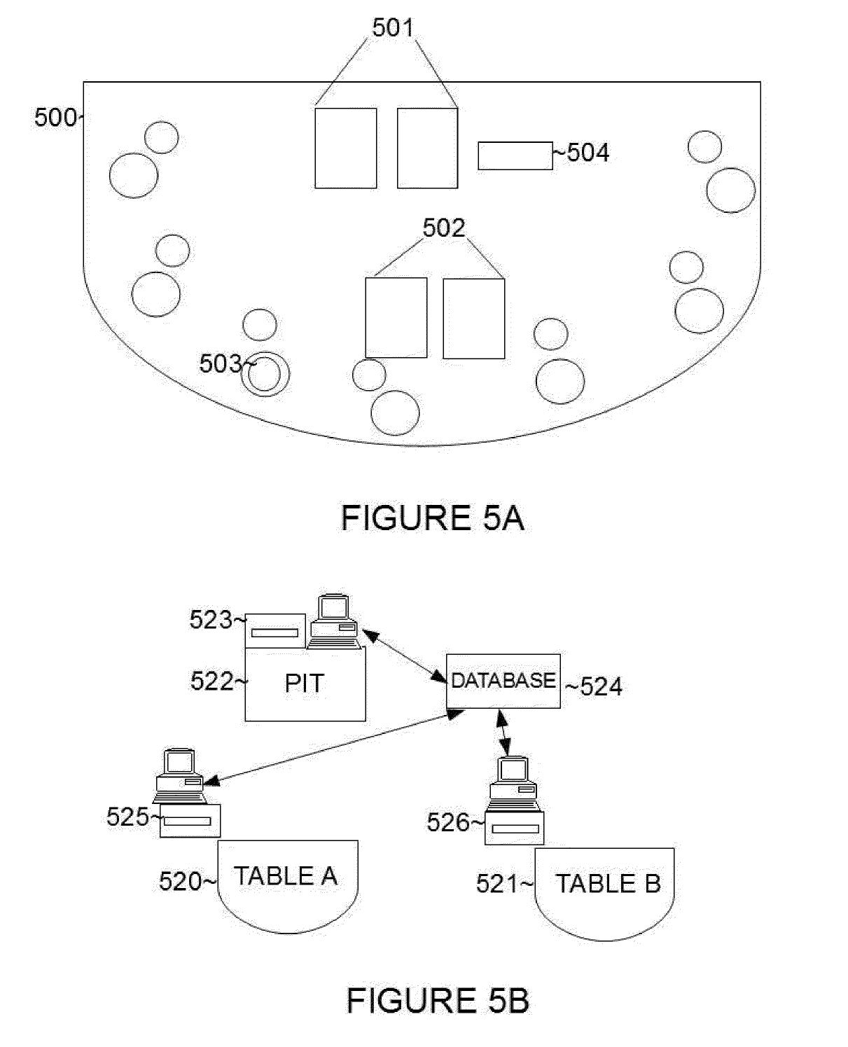

FIG. 5A is a drawing illustrating a gaming table, according to an embodiment.

A physical gaming table 500 (typically made of wood with felt on top with the layout imprinted on it) is used to play the game in a physical real world casino. One example of a table that can be used in a physical casino is illustrated in U.S. Design patent D263,975 which is incorporated by reference herein in its entirety. The layout on top of the felt has imprinted on it seven betting circles as illustrated in FIG. 5A, each betting circle is where the respective player can place their chips (wager). The felt can be green and the imprinted betting circles can be white, although of course any color scheme can be used. Such a table can accommodate any number of players (such as seven as illustrated) or any other number (e.g. 2-10). All players play simultaneously against the dealer as known in the art. A player's hand 502 and a dealer's hand 501 are shown. A player's wager 503 is shown in the form of a chip or chips and is placed inside the player's betting circle. Also shown is a smaller side wager betting circle for each betting circle for each player. The dealer's area can also accommodate a physical card reader 504 for reading the dealer's hole card as described in U.S. Pat. No. 5,681,039, which is incorporated by reference in its entirety for all purposes. The physical card reader can be an electronic card reader which electronically scans a face down card and lights up a particular light (e.g., LED, etc.) if the face down card is a 10 or ace (which would give the dealer blackjack when the dealer's up-card is an ace or 10 respectively) otherwise a different light (e.g., a “green light”) lights up telling the dealer that the hole-card does not give the dealer blackjack and thus the dealer can continue dealing.

While not shown, the game can also be offered with any type of additional side wager in order to generate more action for the casino and more excitement for the players. Also not pictured in FIG. 5A is an electronic mechanical shuffler such as that described in U.S. Pat. No. 8,025,294 which is incorporated by reference here in its entirety which can optionally be used by the dealer to shuffle the deck or decks of cards. Also not pictured in FIG. 5A is an optional shoe which the cards can be placed into and dealt out of by the dealer, such as the shoe described in U.S. Pat. No. 4,457,512 which is incorporated by reference herein in its entirety.

FIG. 5B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through an electronic card readers 323, 325, 326 which can be electronic read and the data therein transmitted to the associated computer.

A gaming table A 520 (which can be used to play any method described herein) and a gaming table B 521 (which can be used to play any method described herein) can be associated with a pit 522 (which has its own computer) which has a card reader 523 to read the electronically encoded information on a player's card (the card reader can also be located at the tables themselves) and transmit the information to an associated computer which can communicate information contained on the player's card (e.g., an identification number of the player associated with the card) to the electronic database 524 along with play data relating to the player who owns the player's card. Table A 520 has its own card reader 525 and associated computer (the one next to card reader 525 which receives information from the card reader 525) and table B 521 also has its own card reader 526 and associated computer (the one next to card reader 326 which receives information from the card reader 526). The computers at table A 520 and table B 521 are connected to the electronic database 524. Casino employees can enter data regarding each player's play (for those players that present a players card) into a computer at the table or at the pit which transmits the play data (e.g., average bet/wager amount, time of play, etc.) to the electronic casino database 524 that stores playing history information for players at the casino. The computers illustrated in FIG. 5B can all have the structure as illustrated in FIG. 5A.

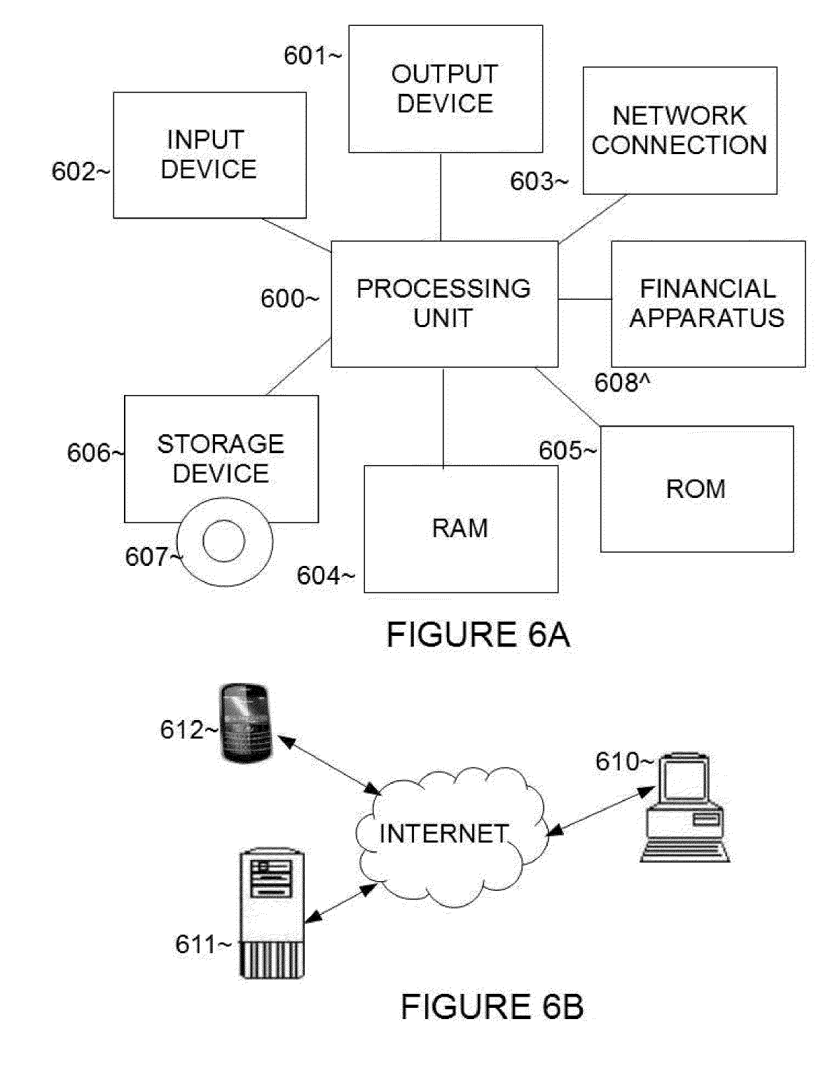

FIG. 6A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety.

A processing unit 600 (such as a microprocessor and any associated components) is connected to an output device 601 (such as an LCD monitor, touch screen, CRT, etc.) which is used to display to the player any aspect of the method, and an input device 602 (e.g., buttons, a touch screen, a keyboard, mouse, etc.) which can be used to input from the player any decision made by the player. All methods described herein can be performed by the processing unit 600 by loading and executing respective instructions. The processing unit 600 can also be connected to a network connection 603, which can connect the electronic gaming device to a computer communications network such as the Internet, a LAN, WAN, etc. The processing unit 600 is also connected to a RAM 604 and a ROM 605. The processing unit 600 is also connected to a storage device 606 which can be a DVD-drive, CD-ROM, flash memory, etc. Multiple such processing units can also work in collaboration with each other (in a same or different physical location). A non-transitory computer readable storage medium 607 can store a program which can control the electronic device to perform any of the methods described herein and can be read by the storage device 606. The processing unit 600 can also be connected to a financial apparatus 608 which can receive cash and convert the received cash into playable credits for use by the player when playing the electronic device. When the player decides to cash out any remaining credits, the financial apparatus 608 can issue coins or a cashless ticket (voucher) for the remaining credits which is redeemable by the player.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 6B is a block diagram illustrating an exemplary network configuration to implement a player playing an online version of the methods described herein. All the methods described herein can be implemented on an online casino for real money (credits which are purchased for cash and are redeemable for cash) or for non-cash value credits. A player uses a personal computer 610 (e.g., cell phone, tablet, PC, etc.) can connect to a server 611 (which can have the structure illustrated in FIG. 5A) using a computer communications network such as the Internet. The server 611 hosts an online casino which determines the outcomes of the game and serves the outcomes to the computer 610 so the computer 610 displays the outcomes to the player. Other users can also play at the online casino hosted by the server 611 simultaneously, such as using a cell phone 612 with wireless internet connectivity. Any number of players connected to the internet can play contemporaneously at the sever 611. The general structure of online casinos is well known in the art.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus for implementing a game, the apparatus comprising:
an electronic input device;
an electronic output device;
an electronic processing unit connected to the input device and the output device, the processing unit configured to:
receive a wager from a player;
deal an initial player's hand and an initial dealer's hand;
a) upon the player having a hard total lesser than a predetermined total, dealing a card to the player;
b) upon the player having a hard total greater than the predetermined total minus one, having the player stand;
c) upon the player having a soft hand, enabling the player to choose to hit or stand;
repeating a, b and c until indefinitely;
resolving the initial dealer's hand into a final dealer's hand; and
resolving the wager.

2. The apparatus as recited in claim 1, wherein the processing unit is further configured such that the predetermined total is 14.

3. The apparatus as recited in claim 1, wherein the processing unit is further configured such that immediately after the initial player's hand is dealt, if the player has a hard total less than the predetermined total then the player is offered an option to double down.

4. The apparatus as recited in claim 3, wherein the processing unit is further configured such that immediately after the initial player's hand is dealt, if the player has a soft point total then the player is offered the option to double.

5. The apparatus as recited in claim 1, wherein the processing unit is further configured such that when the play busts, the player loses one half of the wager.

6. The apparatus as recited in claim 1, wherein the processing unit is further configured such that a winning player blackjack pays even money.

7. An apparatus for implementing a blackjack game, the apparatus comprising:
an electronic input device;
an electronic output device;
an electronic processing unit connected to the input device and the output device, the processing unit configured to:
receive a main wager and a side wager from a player;
deal an initial player's hand and an initial dealer's hand;
determining whether a total of the initial player's hand meets a qualifying condition, wherein the qualifying condition is the total is even or odd;
when the initial player's hand does not meet the condition then the side wager loses;
completing the blackjack game;
when the initial player's hand meets the condition and the player wins the main wager then paying a payout on the side wager at a first payout; and
when the initial player's hand meets the condition and the player loses the main wager then resolving the side wager as a losing wager for the player.

8. The apparatus as recited in claim 7, wherein the processing unit is further configured such that the condition is odd.

9. The apparatus as recited in claim 7, wherein the processing unit is further configured such that the condition is even.

10. The apparatus as recited in claim 7, wherein the processing unit is further configured such that when the initial player's hand meets the condition and the player pushes the main wager then paying a payout on the side wager at a second payout.

11. The apparatus as recited in claim 10, wherein the processing unit is further configured such that the first payout is higher than the second payout.

12. The apparatus as recited in claim 7, wherein when the processing unit is further configured such that the player has a winning blackjack then paying a payout on the side wager.

13. The apparatus as recited in claim 7, wherein when the processing unit is further configured such that when the player has a winning blackjack then paying a payout on the side wager regardless of whether the initial player's hand meets the condition.

14. A method for implementing a game, the method comprising:
a physical deck or decks of cards;
receive a wager from a player in the form of chips;
dealing an initial player's hand and an initial dealer's hand using the physical deck or decks of cards on a physical gaming table;
a) upon the player having a hard total lesser than a predetermined total, dealing a card to the player from the deck or decks of cards;
b) upon the player having a hard total greater than the predetermined total minus one, having the player stand;
c) upon the player having a soft hand, enabling the player to choose to hit or stand;
repeating a, b and c until indefinitely;
resolving the initial dealer's hand into a final dealer's hand; and
resolving the wager by paying additional chips to the player or taking the chips from the player.

15. The method as recited in claim 14, wherein the predetermined total is 14.

16. The method as recited in claim 14, wherein the immediately after the initial player's hand is dealt, if the player has a hard total less than the predetermined total then the player is offered an option to double down.

17. The method as recited in claim 16, wherein immediately after the initial player's hand is dealt, if the player has a soft point total then the player is offered the option to double.

18. The method as recited in claim 14 wherein when the play busts, the player loses one half of the wager.

19. The method as recited in claim 14, wherein a winning player blackjack pays even money.
